(19) United States
(12) Patent Application Publication
(10) Pub. No.: US 2026/0356610 A1
(43) Pub. Date: Nov. 12, 2026

(54) SLIDE RAIL HAVING PULL-IN MECHANISM, PAPER FEEDING DEVICE, AND IMAGE FORMING APPARATUS

(71) Applicant: KYOCERA Document Solutions Inc., Osaka (JP)

(72) Inventors: Akira ISHII, Osaka (JP); Takehiro SATO, Osaka (JP)

(73) Assignee: KYOCERA Document Solutions Inc., Osaka (JP)

(21) Appl. No.: 19/665,330

(22) Filed: May 1, 2026

(30) Foreign Application Priority Data
May 9, 2025 (JP) 2025-079056

(51) Int. Cl. B65H 1/26; G03G 15/00

(52) U.S. Cl. CPC B65H 1/266; G03G 15/6502; B65H 2402/32; B65H 2402/441; B65H 2555/10; B65H 2801/12; G03G 2215/00383

(57) ABSTRACT

A slide rail includes first to third rails, retainers, and a pull-in mechanism. The pull-in mechanism includes a base, a sliding device, a biasing device, a connecting device, and a restricting device. The restricting device is provided on the sliding device and device restricts a position of the second rail when the third rail is connected to the sliding device by the connecting device and completes accommodation of the third rail with respect to the second rail.

### INCORPORATION BY REFERENCE

This application claims priority to Japanese Patent Application No. 2025-079056 filed on May 9, 2025, the entire contents of which are incorporated herein by reference.

### BACKGROUND

The present disclosure relates to a slide rail, a paper feeding device including the same, and an image forming apparatus including the same, and particularly relates to a technique for reliably completing a pull-in operation of the slide rail.

In an image forming apparatus, paper is supplied from a paper feeding device, an image is formed on the paper, and the paper on which the image is formed is discharged. The paper feeding device includes a paper feeding cassette in which a plurality of paper sheets are stacked and accommodated, and paper sheets are drawn one by one from the paper feeding cassette and supplied to the image forming apparatus.

In the paper feeding device, one end of each slide rail is fixed to a main body of the paper feeding device, and the other end of each slide rail is attached to both sides of the paper feeding cassette, and each slide rail supports the paper feeding cassette to be insertable and removable. Each slide rail extends and contracts as the paper feeding cassette is inserted and removed. The paper feeding cassette is drawn out from the main body of the paper feeding device, paper sheets are replenished into the paper feeding cassette, and the paper feeding cassette is pushed into the main body of the paper feeding device, and the paper sheets are drawn and supplied one by one from the paper feeding cassette.

A general slide rail includes an outer rail, a middle rail, an inner rail, and a pull-in mechanism. The pull-in mechanism is provided inside the outer rail, and includes a damper holder fixed to a rear-end side of the outer rail, a slider, two coil springs, and a connecting device. Each coil spring pulls the slider toward the damper holder. The connecting device couples or separates the slider and the inner rail. In a state in which the slider and the inner rail are connected by the connecting device, the slider and the inner rail are pulled toward the damper holder by the coil springs. In a state in which a connection by the connecting device is disconnected and the slider and the inner rail are separated, the inner rail becomes freely movable.

### SUMMARY

As an aspect of the present disclosure, a technique further improving the above-described technique is proposed.

According to an aspect of the present disclosure, a slide rail includes a first rail, a second rail, a third rail, retainers, and a pull-in mechanism. The second rail is movably supported by the first rail. The third rail is movably supported by the second rail. The retainers are provided between the first rail and the second rail and between the second rail and the third rail. The pull-in mechanism is provided on a rear-end side of the first rail and pulls the third rail inward in a rear-end direction of the first rail. The pull-in mechanism includes a base, a biasing device, a connecting device, and a restricting device. The base is fixed to the rear-end side of the first rail. The sliding device is movably supported by the first rail. The biasing device biases the sliding device toward the base and pulls the sliding device inward. The connecting device separates the third rail from the sliding device to make the third rail movable or connects the third rail to the sliding device so that the sliding device and the third rail are pulled toward the base by the biasing device. The restricting device is provided on the sliding device and restricts a position of the second rail when the third rail is connected to the sliding device by the connecting device and completes accommodation of the third rail with respect to the second rail.

According to an aspect of the present disclosure, a paper feeding device includes the above-described slide rail and a paper feeding cassette. The paper feeding cassette is supported by the slide rail in a drawable manner.

According to an aspect of the present disclosure, an image forming apparatus includes the above-described paper feeding device and an image forming device. The image forming device forms an image on paper drawn out and supplied from the paper feeding cassette of the paper feeding device.

### BRIEF DESCRIPTION OF THE DRAWINGS

FIG. 1 is a perspective view showing an external appearance of an image forming apparatus including a paper feeding device to which a slide rail according to an embodiment of the present disclosure is applied.

FIG. 2 is an enlarged perspective view showing an area around a paper feeding cassette of the paper feeding device.

FIG. 3 is a perspective view schematically showing the slide rail.

FIG. 4 is a cross-sectional view showing the slide rail.

FIG. 5 is an enlarged perspective view showing a part of the slide rail.

FIG. 6A is a plan view showing the slide rail in a most contracted state.

FIG. 6B is an enlarged view showing a front-end side of the slide rail.

FIG. 6C is an enlarged view showing an area around a pull-in mechanism.

FIG. 7A is a plan view schematically showing an operation of the pull-in mechanism when the slide rail is contracted.

FIG. 7B is a plan view schematically showing an operation of the pull-in mechanism when the slide rail is contracted.

FIG. 7C is a plan view schematically showing an operation of the pull-in mechanism when the slide rail is contracted.

FIG. 7D is a plan view schematically showing an operation of the pull-in mechanism when the slide rail is contracted.

FIG. 8A is a plan view schematically showing an operation of the pull-in mechanism when the slide rail is extended.

FIG. 8B is a plan view schematically showing an operation of the pull-in mechanism when the slide rail is extended.

FIG. 8C is a plan view schematically showing an operation of the pull-in mechanism when the slide rail is extended.

FIG. 9 is a perspective view showing a guide on one surface at a front-end side of an extension plate in the pull-in mechanism and a boss on one surface of a rotating device.

FIG. 10A is a plan view schematically showing an operation of a pull-in mechanism of a comparative example when the slide rail is contracted.

FIG. 10B is a plan view schematically showing an operation of a pull-in mechanism of a comparative example when the slide rail is contracted.

FIG. 10C is a plan view schematically showing an operation of a pull-in mechanism of a comparative example when the slide rail is contracted.

FIG. 11A is a plan view showing a slide rail in which the most contracted state is not reproduced.

FIG. 11B is an enlarged view showing a front-end side of the slide rail.

FIG. 11C is an enlarged view showing an area around the pull-in mechanism of the comparative example.

### DETAILED DESCRIPTION

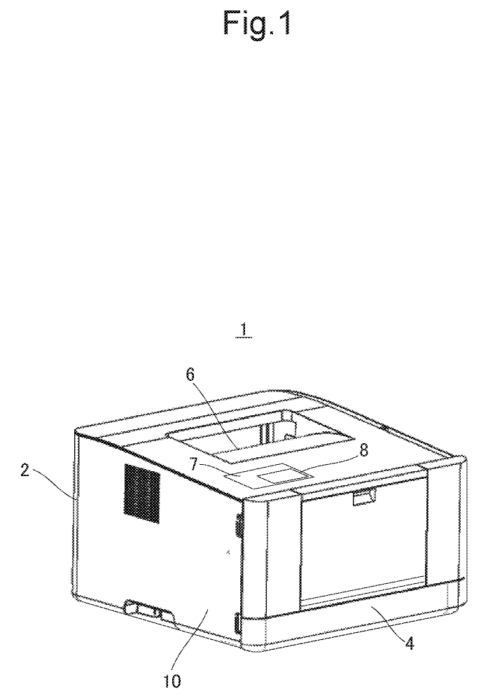

Hereinafter, embodiments of the present disclosure will be described with reference to the drawings. FIG. 1 is a perspective view showing an external appearance of an image forming apparatus including a paper feeding device to which a slide rail according to an embodiment of the present disclosure is applied. As shown in FIG. 1, an image forming apparatus 1 is, for example, a printer, and a main body 2 of the apparatus includes a paper feeding device 10, a discharge tray 6, an operation device 7, a display device 8, and the like and an image forming device and a fixing device (not shown) are provided inside the main body 2 of the apparatus. The paper feeding device 10 includes a paper feeding cassette 4 and the like. A plurality of paper sheets having a standard size are stacked and accommodated in the paper feeding cassette 4, and the paper sheets are drawn out from the paper feeding cassette 4 and conveyed and supplied.

The image forming device forms an image indicated by image data on paper supplied from the paper feeding cassette 4 by an electrophotographic method using toner. The paper on which the image is formed is discharged to the discharge tray 6 after undergoing a fixing process of the fixing device.

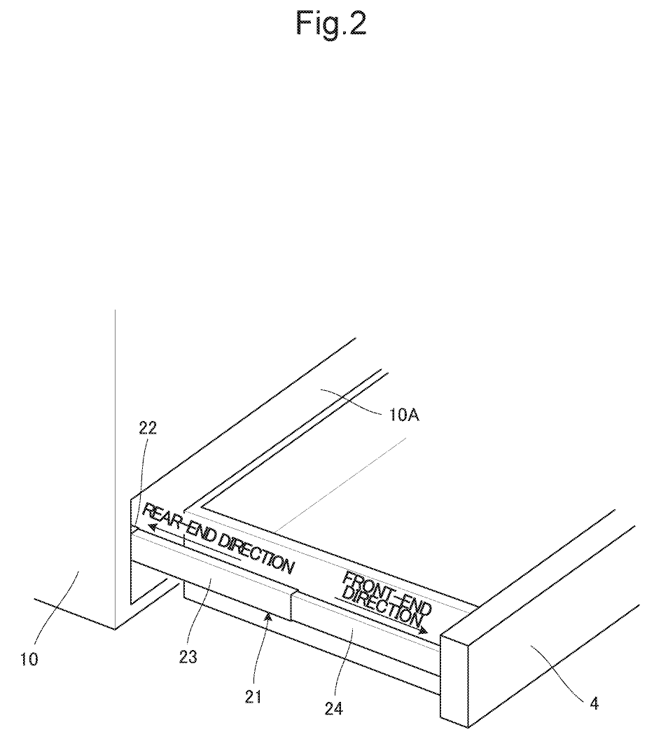

FIG. 2 is an enlarged perspective view showing an area around the paper feeding cassette 4 of the paper feeding device 10. As shown in FIG. 2, the paper feeding cassette 4 is provided in an opening 10A of the main body of the paper feeding device 10 so that the paper feeding cassette 4 is insertable and removable. One slide rail 21 is mounted to bridge between one inner wall of the opening 10A and one outer wall of the paper feeding cassette 4, another slide rail 21 (not shown) is mounted to bridge between another inner wall of the opening 10A and another outer wall of the paper feeding cassette 4, and the two slide rails 21 sandwich and support the paper feeding cassette 4 to be insertable and removable. In a state in which the paper feeding cassette 4 is drawn out from the opening 10A, paper sheets are accommodated and replenished in the paper feeding cassette 4. In a state in which the paper feeding cassette 4 is pushed into the opening 10A, paper sheets are drawn out from the paper feeding cassette 4 and supplied to the image forming device.

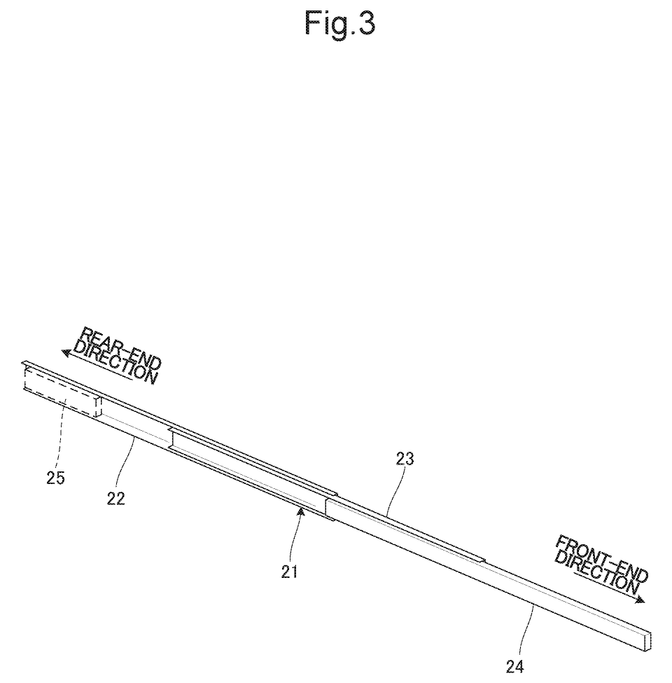

FIG. 3 is a perspective view schematically showing the slide rail 21. As shown in FIG. 3, the slide rail 21 includes an outer rail (an example of a first rail) 22, a middle rail (an example of a second rail) 23 provided inside the outer rail 22 and movably supported by the outer rail 22, an inner rail (an example of a third rail) 24 provided inside the middle rail 23 and movably supported by the middle rail 23, and a pull-in mechanism 25 provided on a rear-end side of the outer rail 22 and pulling the inner rail 24 inward in a one-end direction of the outer rail 22.

As shown in FIGS. 2 and 3, one end in a front-end direction of each of the rails 22 to 24 is defined as a front end of each of the rails 22 to 24, and the other end in a rear-end direction of each of the rails 22 to 24 is defined as a rear end of each of the rails 22 to 24.

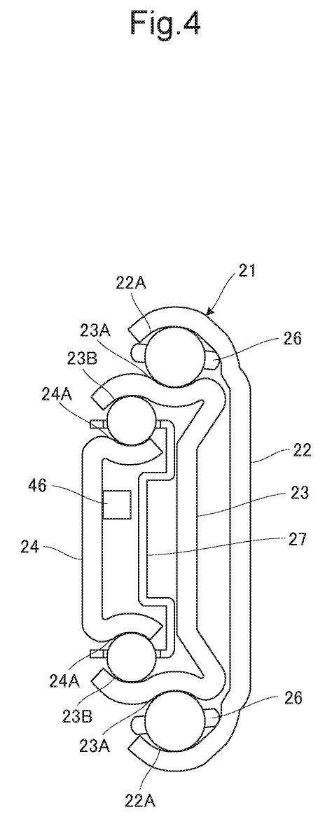

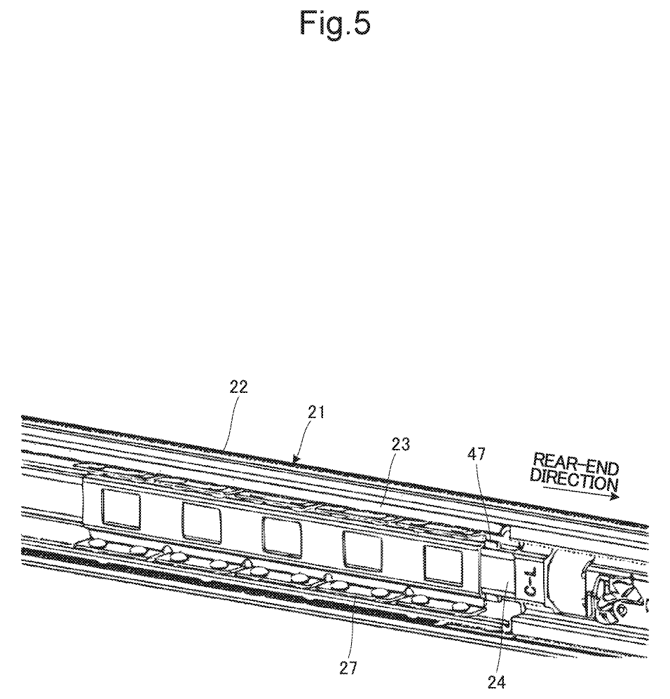

FIG. 4 is a cross-sectional view showing the slide rail 21. Moreover, FIG. 5 is an enlarged perspective view showing a part of the slide rail 21. As shown in FIGS. 4 and 5, the slide rail 21 includes a first ball retainer (an example of a retainer) 26 interposed between the outer rail 22 and the middle rail 23, and a second ball retainer (another example of the retainer) 27 interposed between the middle rail 23 and the inner rail 24.

The first ball retainer 26 is shorter than the middle rail 23 and is movably supported with respect to the outer rail 22 and the middle rail 23. Grooves 22A with which respective balls of the first ball retainer 26 come into contact and along which the balls roll are formed on both inner sides of the outer rail 22, and grooves 23A with which respective balls of the first ball retainer 26 come into contact and along which the balls roll are formed on both outer sides of the middle rail 23.

The middle rail 23 smoothly moves inside the outer rail 22 by rolling of the respective balls of the first ball retainer 26, and the first ball retainer 26 moves by half of a movement amount of the middle rail 23.

The second ball retainer 27 is shorter than the inner rail 24 and is movably supported with respect to the middle rail 23 and the inner rail 24. Grooves 23B with which respective balls of the second ball retainer 27 come into contact and along which the balls roll are formed on both inner sides of the middle rail 23, and grooves 24A with which respective balls of the second ball retainer 27 come into contact and along which the balls roll are formed on both outer sides of the inner rail 24.

The inner rail 24 smoothly moves inside the middle rail 23 by rolling of the respective balls of the second ball retainer 27, and the second ball retainer 27 moves by half of a movement amount of the inner rail 24.

Moreover, a stopper 47 that abuts against the second ball retainer 27 and restricts movement of the second ball retainer 27 in the rear-end direction is provided near a rear end of the middle rail 23.

The outer rail 22, the middle rail 23, the inner rail 24, the first ball retainer 26, and the second ball retainer 27 are formed by sheet metal processing.

When the paper feeding cassette 4 shown in FIG. 2 is drawn out from the opening 10A, the middle rail 23 is drawn out from the outer rail 22 in the front-end direction, and the inner rail 24 is drawn out from the middle rail 23 in the front-end direction, and the slide rail 21 is extended.

Moreover, when the paper feeding cassette 4 is pushed into the opening 10A, the middle rail 23 is pushed into the outer rail 22 in the rear-end direction, and the inner rail 24 is pushed into the middle rail 23 in the rear-end direction, and the slide rail 21 is contracted.

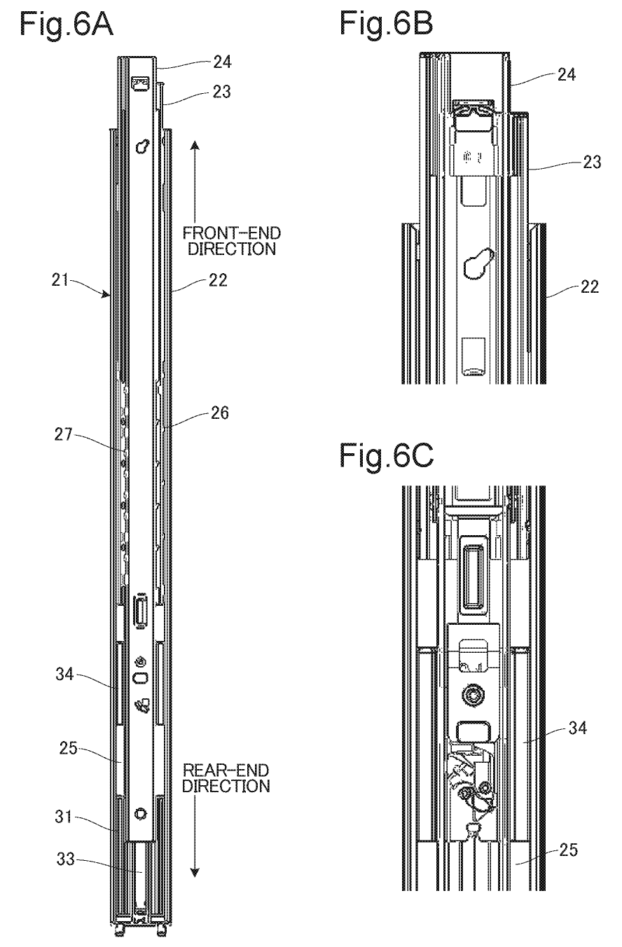

FIG. 6A is a plan view showing the slide rail 21 in the most contracted state. Moreover, FIG. 6B is an enlarged view showing a front-end side of the slide rail 21, and FIG. 6C is an enlarged view showing an area around the pull-in mechanism 25. As shown in FIGS. 6A, 6B,6C, in the most contracted state of the slide rail 21, the middle rail 23 is accommodated inside the outer rail 22, a front-end part of the middle rail 23 slightly protrudes from the outer rail 22, the inner rail 24 is accommodated inside the middle rail 23, and a front-end part of the inner rail 24 slightly protrudes from the middle rail 23.

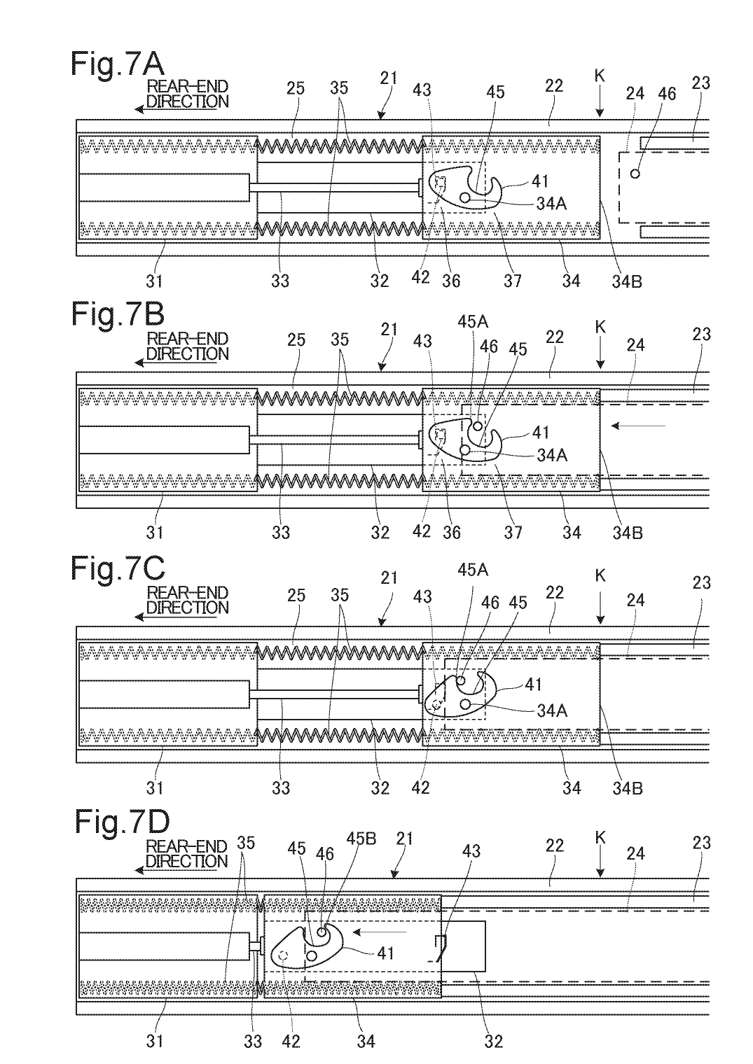

FIG. 7A is an enlarged plan view showing the pull-in mechanism 25. As shown in FIG. 7A, the pull-in mechanism 25 includes a base 31 fixed to an inner rear end of the outer rail 22, an extension plate 32 fixed to the base 31 and configured to extend parallel to the slide rail 21, a damper 33 supported by the base 31, a sliding device 34 movably supported by the outer rail 22, coil springs 35 each biasing the sliding device 34 in the rear-end direction (a direction toward the base 31) to pull the sliding device 34 inward, a holding and releasing device 36 configured to hold the sliding device 34 at a prescribed position K separated from the base 31 against biasing forces of the coil springs 35 or release the sliding device 34 from the prescribed position K so that the sliding device 34 is pulled in the rear-end direction by the coil springs 35, a connecting device 37 configured to separate the inner rail 24 from the sliding device 34 to make the inner rail 24 movable or connect the inner rail 24 to the sliding device 34 so that the sliding device 34 and the inner rail 24 are pulled inward in the rear-end direction by the coil springs 35, and a position restricting device 34B provided on the sliding device 34 and configured to restrict a position of the middle rail 23 when the inner rail 24 is connected to the sliding device 34 by the connecting device 37 and completes accommodation of the inner rail 24 with respect to the middle rail 23.

Both ends of each coil spring 35 are connected to a front end of the sliding device 34 and a rear end of the base 31, and the sliding device 34 is biased and pulled inward in the rear-end direction (toward the base 31) by the biasing forces thereof when the coil springs 35 are in an extended state.

The damper 33 abuts against a rear end of the sliding device 34 that is biased and pulled inward in the rear-end direction by the biasing forces of the coil springs 35, and moderates a moving speed of the sliding device 34.

The holding and releasing device 36 includes a rotating device 41 rotatably supported by a shaft 34A of the sliding device 34, a boss 42 provided to protrude on one surface of the rotating device 41, and a guide 43 formed on one surface at a front-end side of the extension plate 32.

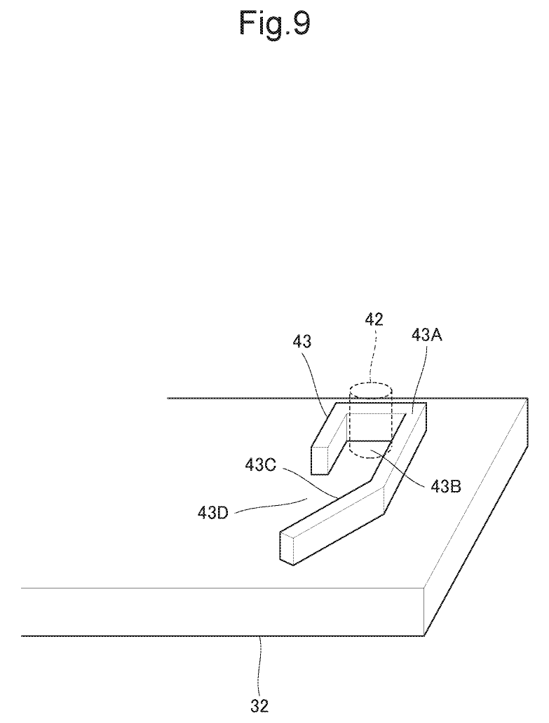

FIG. 9 is a perspective view showing the guide 43 on one surface at the front-end side of the extension plate 32 and the boss 42 on one surface of the rotating device 41. As shown in FIG. 9, the guide 43 is bordered by a guide wall 43A formed on one surface at the front-end side of the extension plate 32, and a boss holding device 43B, an inclined guide surface 43C, and a boss insertion/removal device 43D are formed inside the guide wall 43A. The one surface of the rotating device 41 on which the boss 42 is provided to protrude and the one surface at the front-end side of the extension plate 32 on which the guide 43 is formed face each other. When the boss 42 of the rotating device 41 enters the boss insertion/removal device 43D of the guide 43 and moves from the inclined guide surface 43C to the boss holding device 43B, the boss 42 of the rotating device 41 is held by the boss holding device 43B of the guide 43, the rotating device 41 stops, and the sliding device 34 supporting the rotating device 41 stops at a prescribed position K as shown in FIG. 7A. Moreover, if the boss 42 of the rotating device 41 moves from the boss holding device 43B of the guide 43 to the inclined guide surface 43C and exits from the boss insertion/removal device 43D, the rotating device 41 becomes movable in the rear-end direction (toward the base 31), and the sliding device 34 supporting the rotating device 41 also becomes movable in the same direction.

Moreover, in FIG. 7A, the connecting device 37 includes the rotating device 41 rotatably supported by the shaft 34A on the rear-end side of the sliding device 34, a curved hook 45 formed on the rotating device 41, and a pin 46 provided to protrude on one surface at the rear-end side of the inner rail 24. As is also clear from FIG. 4, the pin 46 is provided to protrude on one surface of the inner rail 24. When the inner rail 24 moves in the rear-end direction (toward the base 31), the pin 46 on the rear-end side of the inner rail 24 enters an inside of the curved hook 45 of the rotating device 41, and the rotating device 41 rotates counterclockwise about the shaft 34A, the inner rail 24 and the sliding device 34 are connected by the connecting device 37. Moreover, when the rotating device 41 rotates clockwise about the shaft 34A, the inner rail 24 moves in a direction opposite to the base 31, and the pin 46 on the rear-end side of the inner rail 24 exits to an outside of the curved hook 45 of the rotating device 41, the inner rail 24 and the sliding device 34 are separated.

Because the holding and releasing device 36 and the connecting device 37 share the rotating device 41 rotatably supported by the shaft 34A of the sliding device 34, they are linked with each other.

Furthermore, the outer rail 22 corresponds to the first rail in the claims. The middle rail 23 corresponds to the second rail in the claims. The inner rail 24 corresponds to the third rail in the claims. The first ball retainer 26 and the second ball retainer 27 correspond to the retainer in the claims. The pull-in mechanism 25 corresponds to the pull-in mechanism in the claims. The base 31 corresponds to the base in the claims. The sliding device 34 corresponds to the sliding device in the claims. The coil springs 35 correspond to the biasing device in the claims. The holding and releasing device 36 corresponds to the holding and releasing device in the claims. The connecting device 37 corresponds to the connecting device in the claims. The position restricting device (an example of a restricting device) 34B corresponds to the restricting device in the claims.

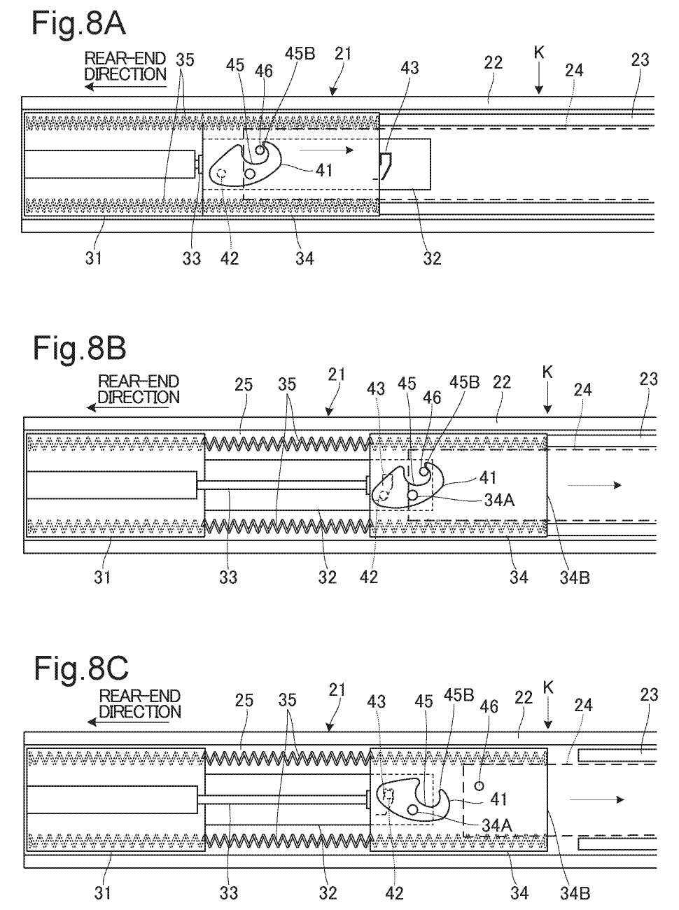

Here, an operation of the pull-in mechanism 25 will be described with reference to FIGS. 7A-7D and 8A-8C . As shown in FIG. 7A, in a state in which the slide rail 21 is extended and the middle rail 23 and the inner rail 24 are separated from the sliding device 34, the rotating device 41 of the sliding device 34 rotates clockwise about the shaft 34A, and the boss 42 of the rotating device 41 is held by the boss holding device 43B of the guide 43. In this state, the rotating device 41 stops, and the sliding device 34 supporting the rotating device 41 stops at the prescribed position K. At this time, because each coil spring 35 is extended, the sliding device 34 is held at the prescribed position K against the biasing forces of the respective coil springs 35.

Therefore, the holding and releasing device 36 holds the sliding device 34 at the prescribed position K separated from the base 31 against the biasing forces of the respective coil springs 35.

As shown in FIGS. 7B and 7C, when the slide rail 21 is contracted and the middle rail 23 and the inner rail 24 move in the rear-end direction, the rear end of the middle rail 23 abuts against the position restricting device 34B of the sliding device 34 (the front end of the sliding device 34), and the inner rail 24 further moves, and the pin 46 on the rear-end side of the inner rail 24 enters the curved hook 45 of the rotating device 41, and the pin 46 pushes away the rear end 45A of the curved hook 45, and the rotating device 41 rotates counterclockwise about the shaft 34A. At this time, the boss 42 of the rotating device 41 moves in the order of the boss holding device 43B → the inclined guide surface 43C → the boss insertion/removal device 43D (shown in FIG. 9) of the guide 43, and exits from the boss insertion/removal device 43D. Thereby, the rotating device 41 becomes movable in the rear-end direction, and the sliding device 34 supporting the rotating device 41 also becomes movable in the same direction. As shown in FIGS. 7C and 7D, the middle rail 23 first abuts against the position restricting device 34B of the sliding device 34 and stops, and thereafter the inner rail 24 is pulled toward the base 31 by the coil springs 35. Until the sliding device 34 is moved in the rear-end direction and stops, the moving speed of the sliding device 34 is suppressed and moderated by the damper 33.

Therefore, an operation of the connecting device 37 for connecting the inner rail 24 to the sliding device 34 and an operation of the holding and releasing device 36 for releasing the sliding device 34 from the prescribed position K and causing the sliding device 34 to be pulled inward in the rear-end direction by the respective coil springs 35 are linked, and the sliding device 34 and the inner rail 24 are pulled inward in the rear-end direction by the respective coil springs 35.

Next, as shown in FIGS. 8A, 8B, and 8C, when the slide rail 21 is extended and the middle rail 23 and the inner rail 24 move away from the sliding device 34, the boss 42 of the rotating device 41 of the sliding device 34 enters the boss insertion/removal device 43D of the guide 43 of the extension plate 32 and moves from the inclined guide surface 43C to the boss holding device 43B. Also, the boss 42 of the rotating device 41 is held by the boss holding device 43B of the guide 43, the rotating device 41 stops, and the sliding device 34 supporting the rotating device 41 stops at the prescribed position K.

As shown in FIG. 8C, when the inner rail 24 further moves, the pin 46 on the rear-end side of the inner rail 24 pushes away the front end 45B of the curved hook 45 of the rotating device 41, and the rotating device 41 rotates clockwise about the shaft 34A. Also, the pin 46 on the rear-end side of the inner rail 24 exits to the outside of the curved hook 45 of the rotating device 41, the inner rail 24 and the sliding device 34 are separated, the inner rail 24 moves in a direction away from the base 31, and the middle rail 23 also moves in a direction away from the base 31. Thereby, as shown in FIG. 7A, the slide rail 21 is extended, and the middle rail 23 and the inner rail 24 are separated from the sliding device 34.

Therefore, an operation of the holding and releasing device 36 for holding the sliding device 34 at the prescribed position K separated from the base 31 against the biasing forces of the respective coil springs 35 and an operation of the connecting device 37 for separating the inner rail 24 from the sliding device 34 to make the inner rail 24 movable are linked.

Here, because the relative positions of the middle rail 23 and the inner rail 24 may vary depending on prior pull-out and push-in operations, conventionally, even if the inner rail 24 is pulled inward by the pull-in mechanism 25, the accommodation of the inner rail 24 may not be completed with respect to the middle rail 23.

Therefore, in the present embodiment, the length of the sliding device 34 is appropriately set, the front end of the sliding device 34 is used as the position restricting device 34B, and the position of the middle rail 23 is restricted by the position restricting device 34B of the sliding device 34 when the inner rail 24 is pulled inward by the pull-in mechanism 25, thereby completing the accommodation of the inner rail 24 with respect to the middle rail 23.

Specifically, as shown in FIGS. 7B and 7C, when the slide rail 21 is contracted in accordance with a push-in operation of the paper feeding cassette 4 and the middle rail 23 and the inner rail 24 move toward the sliding device 34, first, the rear end of the middle rail 23 abuts against the position restricting device 34B (the front end of the sliding device 34) of the sliding device 34, and the middle rail 23 stops. Furthermore, the inner rail 24 moves, the pin 46 on the rear-end side of the inner rail 24 pushes away the rear end 45A of the curved hook 45, the rotating device 41 rotates counterclockwise about the shaft 34A, and at the same time, as shown in FIGS. 7C and 7D, the movement of the sliding device 34 in the rear-end direction is started by the biasing forces of the respective coil springs 35 of the pull-in mechanism 25. Because the operations from FIGS. 7B-7D are performed by an operating force applied when the paper feeding cassette 4 is pushed inward, the inner rail 24 is moved sufficiently in a state in which the middle rail 23 is stopped, and the accommodation of the inner rail 24 is reliably completed with respect to the middle rail 23.

Subsequently, if the movement of the sliding device 34 by the biasing forces of the respective coil springs 35 is started, the pin 46 on the rear-end side of the inner rail 24 catches on the front end 45B of the curved hook 45 of the rotating device 41 of the sliding device 34, and the movement of the inner rail 24 in the rear-end direction is also started. At this time, the second ball retainer 27 abuts against the stopper 47 (shown in FIG. 5) provided on the middle rail 23 and stops, the middle rail 23 and the inner rail 24 become integrated inside the outer rail 22 and are smoothly moved in the rear-end direction by the first ball retainer 26, and the slide rail 21 reaches the most contracted state.

Accordingly, when the inner rail 24 is moved in the rear-end direction by the biasing forces of the respective coil springs 35, the accommodation of the inner rail 24 is completed with respect to the middle rail 23, and the middle rail 23 and the inner rail 24 become integrated inside the outer rail 22 and are smoothly moved in the rear-end direction by the first ball retainer 26.

Therefore, even if pull-out and push-in operations of the paper feeding cassette 4 are repeated and the relative positions of the middle rail 23 and the inner rail 24 are indefinite, the accommodation of the inner rail 24 can be completed with respect to the middle rail 23, and the most contracted state of the slide rail 21 as shown in FIGS. 6A, 6B, and 6C, can be reliably reproduced by the pull-in mechanism 25.

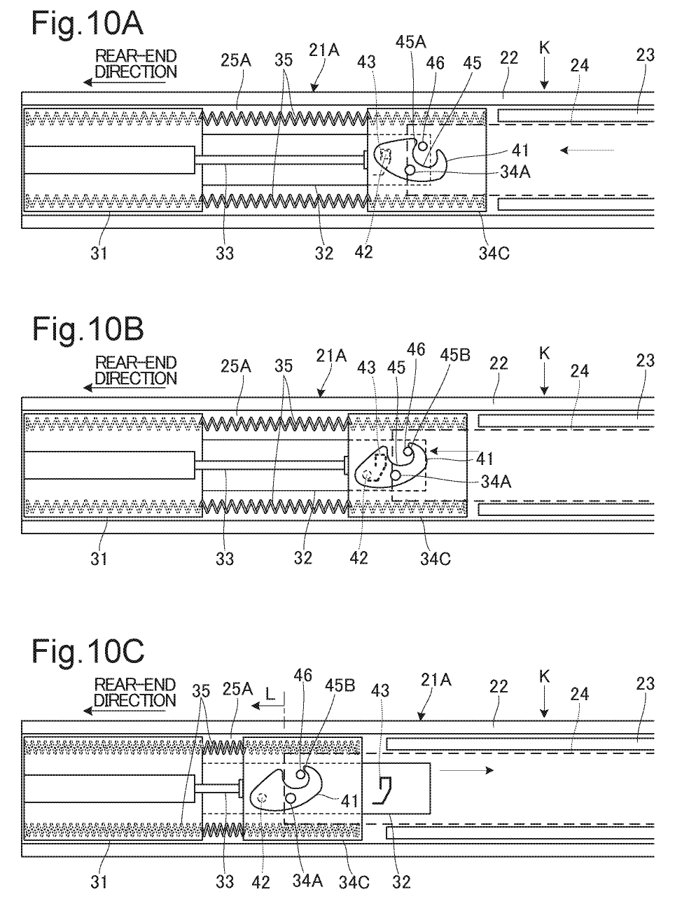

FIGS. 10A, 10B, and 10C show a configuration of a comparative example with respect to the present embodiment, and show an operation of a pull-in mechanism 25A of the comparative example when the slide rail 21 is contracted. In the pull-in mechanism 25A of this comparative example, a sliding device 34C is made shorter than the above sliding device 34. Therefore, as shown in FIGS. 10A and 10B, when the middle rail 23 and the inner rail 24 move, before the middle rail 23 abuts against the front end of the sliding device 34C, the pin 46 on the rear-end side of the inner rail 24 catches on the front end 45B of the curved hook 45 of the rotating device 41, and the inner rail 24 is moved in the rear-end direction by the biasing forces of the respective coil springs 35. At this time, relative positions of the middle rail 23 and the inner rail 24 change, and the second ball retainer 27 may reach and stop at the stopper 47 (shown in FIG. 5) on the middle rail 23 side. In this case, the respective balls of the second ball retainer 27 between the middle rail 23 and the inner rail 24 do not roll, the movement load of the inner rail 24 increases, the movement of the inner rail 24 by the biasing forces of the respective coil springs 35 becomes difficult, the accommodation of the inner rail 24 is not completed with respect to the middle rail 23 as shown in FIG. 10C, the front end of the inner rail 24 is not accommodated by a length L, and a pull-in failure in which the most contracted state of the slide rail 21 is not reproduced by the pull-in mechanism 25 occurs.

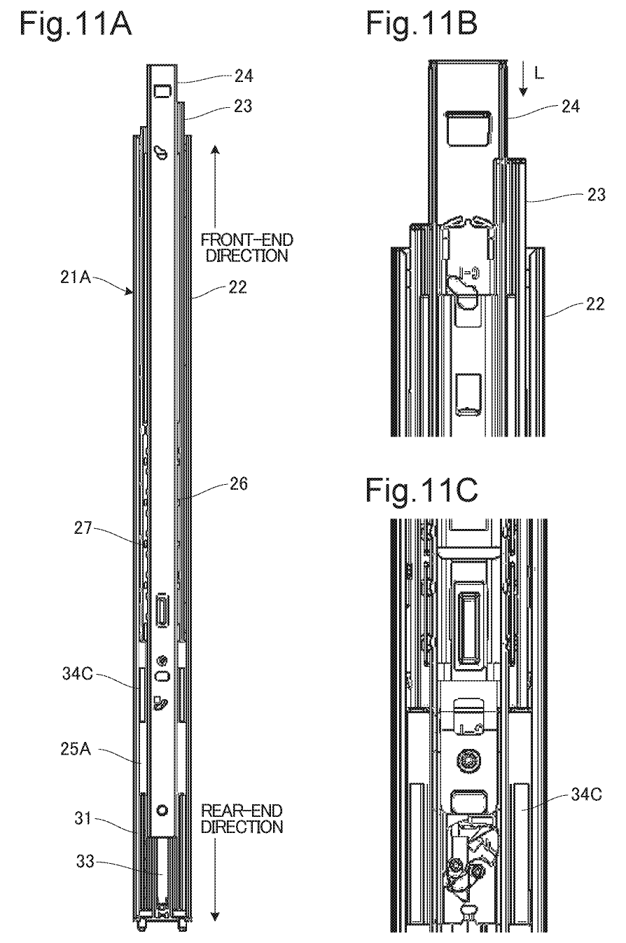

FIG. 11A shows a configuration of a comparative example for the present embodiment, and is a plan view showing the slide rail 21 in which the most contracted state is not reproduced by the pull-in mechanism 25A of the comparative example. Moreover, FIG. 11B is an enlarged view showing a front-end side of the slide rail 21, and FIG. 11C is an enlarged view showing an area around the pull-in mechanism 25A of the comparative example. As shown in FIGS. 11A, 11B, and 11C, the accommodation of the inner rail 24 is not completed with respect to the middle rail 23, the front end of the inner rail 24 is not accommodated by a length L, and the most contracted state of the slide rail 21 is not reproduced by the pull-in mechanism 25A.

In contrast, in the present embodiment, at the start of the pull-in operation of the slide rail 21 by the pull-in mechanism 25, the position of the middle rail 23 is restricted by the position restricting device 34B of the sliding device 34, and the inner rail 24 is moved, thereby completing the accommodation of the inner rail 24 with respect to the middle rail 23 without increasing movement load. Therefore, the most contracted state of the slide rail 21 can be reliably reproduced by the pull-in mechanism 25.

Although a printer is exemplified as an example of the image forming apparatus of the present disclosure in the above-described embodiment, this is only an example, and a multifunctional device, a copying machine, a facsimile apparatus, or the like may also be used.

Here, in a general slide rail, an outer rail is fixed to a main body of a paper feeding device, and an inner rail is attached to a paper feeding cassette. When the slide rail extends and contracts in accordance with insertion and removal of the paper feeding cassette, a middle rail relatively moves with respect to the outer rail and the inner rail. The pull-in mechanism pulls the inner rail inward upon the completion of contraction of the slide rail.

However, at the start of the pull-in operation of the slide rail by the pull-in mechanism, the accommodation of the inner rail may not be completed with respect to the middle rail, and this may cause a pull-in failure of the slide rail.

The present embodiment has been made in view of the above circumstances, and completes accommodation of the inner rail with respect to the middle rail at the start of the pull-in operation of the slide rail by the pull-in mechanism, thereby preventing the pull-in failure of the slide rail in advance.

Moreover, the configuration of the above embodiment described with reference to FIGS. 1-9 is only one example of the present disclosure, and is not intended to limit the present disclosure to that configuration.

While the present disclosure has been described in detail with reference to the embodiments thereof, it would be apparent to those skilled in the art that the various changes and modifications may be made therein within the scope defined by the appended claims.

What is claimed is:

1. A slide rail comprising:
a first rail;
a second rail movably supported by the first rail;
a third rail movably supported by the second rail;
retainers provided between the first rail and the second rail and between the second rail and the third rail; and
a pull-in mechanism provided on a rear-end side of the first rail and configured to pull the third rail inward in a rear-end direction of the first rail,
wherein the pull-in mechanism includes:
a base fixed to the rear-end side of the first rail;
a sliding device movably supported by the first rail;
a biasing device configured to bias the sliding device toward the base and pull the sliding device inward;
a connecting device configured to separate the third rail from the sliding device to make the third rail movable or connect the third rail to the sliding device so that the sliding device and the third rail are pulled toward the base by the biasing device; and
a restricting device provided on the sliding device and configured to restrict a position of the second rail when the third rail is connected to the sliding device by the connecting device and complete accommodation of the third rail with respect to the second rail.

2. The slide rail according to claim 1,
wherein the pull-in mechanism includes a holding and releasing device configured to hold the sliding device at a prescribed position separated from the base against a biasing force of the biasing device or release the sliding device from the prescribed position so that the sliding device is pulled toward the base by the biasing device,
wherein an operation of the holding and releasing device for holding the sliding device at the prescribed position and an operation of the connecting device for separating the third rail from the sliding device to make the third rail movable are linked, and
wherein an operation of the connecting device for connecting the third rail to the sliding device and an operation of the holding and releasing device for releasing the sliding device from the prescribed position so that the sliding device is pulled toward the base by the biasing device are linked.

3. The slide rail according to claim 2, wherein the holding and releasing device and the connecting device share a rotating device rotatably supported by a shaft of the sliding device.

4. A paper feeding device comprising:
the slide rail according to claim 1; and
a paper feeding cassette supported by the slide rail in a drawable manner.

5. An image forming apparatus comprising:
the paper feeding device according to claim 4; and
an image forming device configured to form an image on paper drawn out and
supplied from the paper feeding cassette of the paper feeding device.
